(19) United States
(12) Patent Application Publication
(10) Pub. No.: US 2006/0124538 A1
(43) Pub. Date: Jun. 15, 2006

(54) Filtering medium comprising mineral fibres obtained by means of centrifugation

(75) Inventors: Alice Morcrette, Amiens (FR); Jean-Pierre Maricourt, Compiegne (FR); Laurent Piercucci, Carmarma de Esteruelas (ES); Eerik Nousiainen, Gouvieux (FR); Jean-Dominique Depuille, Boulincourt (FR); Eric Vandenhecke, Mogneville (FR)

Correspondence Address: OBLON, SPIVAK, MCCLELLAND, MAIER & NEUSTADT, P.C., 1940 DUKE STREET, ALEXANDRIA, VA, 22314, US

(73) Assignee: SAINT-GOBAIN ISOVER, courbevoie (FR)

(21) Appl. No.: 10/514,847

(22) PCT Filed: May 21, 2003
(86) PCT No.: PCT/FR03/01530

§ 371 Date: Aug. 25, 2005

(30) Foreign Application Priority Data
May 27, 2002 (FR) 02/06547

(51) Int. Cl. B01D 39/04

(52) U.S. Cl. 210/503

(57) ABSTRACT

A process for manufacturing a filter medium including a felt of mineral fibers bonded to a veil. The process forms fibers by a device employing internal centrifuging, that includes a fiberizing spinner dish. Then, a precursor of a binder is sprayed onto the fibers. Then, the fibers are collected on a veil. And then, a heat treatment of the assembly including the fibers and the veil is performed with a controlled thickness to convert the binder precursor into a binder. The filter medium thus obtained allows the production of particularly effective pocket filters.

The invention relates to a filter medium for the production of filters, especially a pocket filter, and its manufacturing process. The invention relates especially to fine high-efficiency pocket filters of classes F5 to F9 according to the EN 779 standard, for the filtration of gases and more particularly air (elimination of particles suspended in air).

It is known to make pocket filters that meet the abovementioned standard from filter media prepared by what is called the “Aerocor” process whereby fibers are attenuated horizontally in a horizontal flame with a high gas flow rate from vertical glass rods. After the fibers are formed, they are collected as a sheet on a belt provided with holes, said belt being inclined to the horizontal. However, it is endeavored to improve the effectiveness of these filters and lower the pressure drop that they occasion.

The filter medium according to the invention is prepared by a process comprising the following steps:

formation of fibers by a device employing the process referred to as internal centrifuging; then

spraying a precursor of a binder onto the fibers; then

collecting the fibers on a veil; and then

heat treatment of the assembly comprising the fibers and the veil with a controlled thickness so as to convert the binder precursor into a binder.

The filter medium thus obtained comprises a felt composed of the bonded mineral fibers, said felt being adhesively bonded to the veil. The precursor of a binder, sprayed just after attenuation of the fibers is converted into a binder during the heat treatment, said binder, on the one hand, serving to bind the fibers together, in order to give them a felt structure, and, on the other hand, serving to adhesively bond the felt to the veil.

In general, for collecting the fibers on the veil, the latter is placed on a gas-permeable belt, said fibers being directed onto said veil by suction being applied through said veil and said belt.

For a given weight per unit area, the filter medium according to the invention sets a low pressure drop against the gas flowing through it. The same applies with the filters produced from the filter medium according to the invention.

In addition, for a given weight per unit area, the filter medium according to the invention has a high particle retention capacity (also called clogging capacity). It is generally accepted that a pocket filter is spent (that is to say blocked too much by the dust particles that it has filtered) when it presents a pressure drop of 450 pascals to the gas. The retention capacity is therefore the weight of dust per unit area that the filter contains when it presents the said pressure drop of 450 pascals. This advantage of the filter medium according to the invention allows the use of a lower grammage, while still maintaining a high retention capacity and presenting a low pressure drop.

The remarkable properties of the filter medium according to the invention probably stem from the particular structure of the fiber network. In particular, and without this explanation limiting the scope of the present application, the fibers could have a particularly random orientation.

The principle of the internal centrifuging process is itself well known to those skilled in the art. Schematically, this process consists in introducing a stream of molten mineral material in a spinner, also called a fiberizing spinner dish, rotating at high speed and pierced around its periphery with a very large number of holes through which the molten material is thrown in the form of filaments due to the effect of the centrifugal force. These filaments are then subjected to the action of a high-temperature high-velocity annular attenuating stream hugging the wall of the spinner, which stream attenuates the filaments and converts them into fibers. The fibers formed are entrained by this attenuating gas stream to a collecting device generally formed by a gas-permeable belt. This known process has formed the subject of many improvements, including in particular those taught in European Patent Applications No. EP 0 189 534, EP 0 519 797 or EP 1 087 912.

In the process according to the invention, the holes in the spinner dish must have a sufficiently small diameter for the fibers obtained by the internal centrifuging process to have a fineness index of at most 12 liters per minute, preferably at most 10 liters per minute, and generally at least 0.4 liters per minute, the said fineness index being measured by the technique described in French Patent Application No. FR 02/06252 filed on May 22, 2002. This patent application relates in fact to a device for determining the fineness index of fibers that includes a fineness index measuring device, said fineness index measuring device being provided, on the one hand, with at least a first orifice connected to a measurement cell suitable for housing a specimen formed from a plurality of fibers and, on the other hand, with a second orifice connected to a differential pressure measuring device located on either side of said specimen, said differential pressure measuring device being intended to be connected to a fluid flow production device, characterized in that the fineness index measuring device comprises at least one volumetric flow meter for the fluid flowing through said cell. This device gives correspondences between “micronaire” values and liters per minute, whenever the fiber is thick enough for micronaire values to exist. For very fine fibers, such as those used within the context of the present invention, a fineness may be measured in l/min using the technique of the abovementioned patent, although no “micronaire” value exists.

To obtain fibers with the required fineness, it is possible in particular to use, as device for implementing the internal centrifuging process, that described in patent application No. EP 1 087 912. Generally, the holes in the spinner dish have a diameter ranging from 0.3 to 0.9 mm and more generally ranging from 0.4 to 0.8 mm. For a 400 mm diameter spinner dish, this may have 1500 to 15000 holes. These holes may be arranged around the peripheral band of the spinner dish in a multitude of superposed horizontal rows, for example 5 to 20 rows. The spinner dish may have a diameter other than 400 mm, for example 600 mm, and the number of holes varies in relation to that which the change in diameter implies as regards the area of the peripheral band of the spinner dish, so that the number of holes per unit area remains approximately that in the precise case of 1500 to 15000 holes for a 400 mm diameter spinner dish. Finer fibers are obtained if the diameter of the holes in the spinner dish are reduced and/or if their attenuation is increased.

Preferably, the device is provided with an internal burner. Preferably, the device is set so as to give a low output per hole. Just after fiberizing, the fibers are attenuated in a burner, for example a loop burner, especially of the tangential burner type. Preferably, the device is provided with a tangential burner, that is to say one having a tangential component that attenuates the fibers in order to end up with their final diameter (generally of the order of about 1 μm), especially as described in patent application No. EP 0 189 354.

Preferably, the fiberizing is set so that the output ranges from 0.1 to 1 kg per hole in the spinner dish and per day.

Preferably, the fiberizing spinner dish has no bottom and is combined with a basket as in patent application No. EP 0 189 354.

The process according to the invention allows continuous manufacture of sheets of the filter medium according to the invention. Such a process consumes a small amount of fuel for a high productivity, compared with the Aerocor process. A productivity of around 200 to 5000 kg per day may be achieved. A productivity of 1000 kg/day for a consumption of around 3 to 10 Sm³/h of combustible gas may be achieved, compared with a productivity of 120 kg/day and a consumption of 100 Sm³/h of combustible gas in the case of the Aerocor process. The total energy to fiberize 1 kg of glass fibers is around 20 kW/h with the internal centrifuging process, whereas it is 85 kW/h in the case of the Aerocor process.

The sprayed precursor of the binder may be of the phenolic or acrylic or epoxy type. Depending on its nature, this precursor may be sprayed in the form of a solution or an emulsion. The sprayed mass generally contains a high proportion of water, the water content ranging, for example, from 70 to 98%, especially around 90%. The rest of the sprayed mass comprises the precursor of the binder and optionally an oil and optionally additives such as, for example a silane, to optimize the interface between the fiber and the binder, or a biocide. The sum of the amounts of oil and additives generally ranges from 0 to 5% by weight of the mass of precursor, especially from 1 to 3% by weight of the mass of precursor. The oil may especially be that of the MULREX 88 brand sold by Exxon Mobil.

The mineral material that is converted into fiber is generally glass. Any type of glass that can be converted by the internal centrifuging process may be suitable. In particular, it may be a lime borosilicate glass, and especially a biosoluble glass.

The veil is generally made of a polyester or a polypropylene or a glass and generally has a weight per unit area (or grammage) ranging from 5 to 100 g/m².

The heat treatment serves to convert the binder precursor into the binder by causing chemical solidification (crosslinking or curing) reactions and by evaporating the volatile species (solvent, reaction products, etc.). After this heat treatment, the fibers are bound together in the felt and the felt is bonded to the veil. This operation is carried out while maintaining the thickness of the filter medium during the solidification reaction, this generally being achieved by keeping the felt/veil assembly between two running belts that are placed a constant distance apart, said distance corresponding to the desired total thickness of the filter medium. This thickness may, for example, range from 4 to 12 mm, for example about 7 mm.

The final filter medium, which may be in the form of a sheet and formed from the felt comprising the mineral fibers, the veil and the binder generally comprises:

10 to 25% by weight of binder+oil (where appropriate)+additive(s) (where appropriate);

10 to 50% by weight of veil; and

25 to 80% by weight of mineral material, generally glass.

As just stated, the sum of the mass of binder, oil and additive may represent 10 to 25% by weight of the mass of the filter medium.

The final filter medium is generally manufactured continuously, in which case it appears as a reelable sheet and its weight per unit area may range from 30 to 110 g/m² and more generally from 50 to 90 g/m². The width of the sheet may range, for example, from 1 to 3 meters. The sheet of filter medium may then be cut into squares or rectangles, which are then assembled in a manner known to those skilled in the art to order to produce pocket filters.

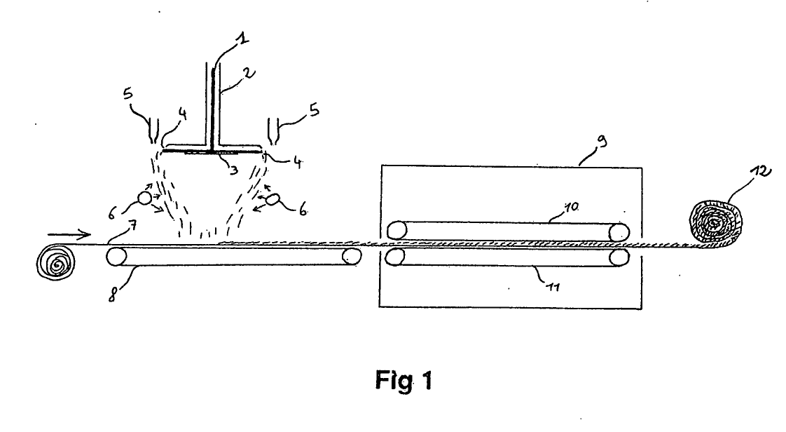

FIG. 1 shows schematically the process according to the invention. A stream of molten mineral material 1 drops down the center of the hollow spindle 2 of the spinner and touches the basket 3, and then said material is thrown by centrifugation against the fiberizing spinner dish 4 provided with holes. The molten material passes through the holes in the form of fibers and these fibers are then attenuated using tangential burners 5. The spray nozzles 6 spray the binder precursor onto the fibers, which are then collected on the veil 7, which is itself driven by a gas-permeable belt 8. Suction (not shown in FIG. 1) acts through the belt in order to attract the fibers onto the surface of the veil and to keep them thereon. The fiber/veil assembly is then taken into an oven 9 where the binder precursor is converted to the binder. In this oven, the filter medium is gripped between two running belts 11 and 12, separated from each other by the desired distance for the final thickness of the filter medium. After the binder has solidified, the filter medium according to the invention may be reeled up at 12. The internal burner, which is not shown, attenuates the fibers output by the fiberizing spinner dish 4.

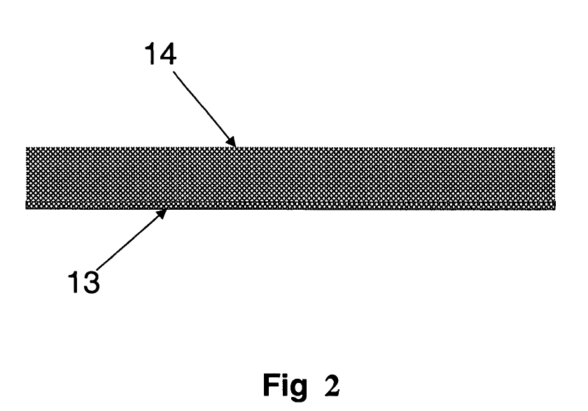

FIG. 2 shows the filter medium according to the invention, which comprises a veil 13 to which a fiber felt 14 is adhesively bonded.

The efficiency of a pocket filter is characterized by the classes F5 to F9 of the EN 779 standard. These classes depend directly on the mean spectral efficiency within the meaning of the EN 779 standard.

The invention makes it possible in particular to produce pocket filters having a mean spectral efficiency ranging from 80 to 90% and having a retention capacity as measured according to the EN 779 standard, with a mean spectral efficiency at 0.6 μm, of at least 45 g/m², and even at least 50 g/m², or indeed at least 60 g/m², for a filter medium having a weight per unit area of 60 to 70 g/m².

The invention also makes it possible to produce pocket filters having a mean spectral efficiency ranging from 60 to 80% and having a retention capacity as measured according to the EN 779 standard, with a mean spectral efficiency at 0.6 μm, of at least 50 g/m², and even at least 60 g/m², or indeed at least 70 g/m², for a filter medium having a weight per unit area ranging from 70 to 90 g/m².

The invention also makes it possible to produce pocket filters having a mean spectral efficiency ranging from 40 to 60% and having a retention capacity, as measured according to the EN 779 standard, with a mean spectral efficiency at 0.6 μm, of at least 60 g/m², and even at least 70 g/m², for a filter medium having a weight per unit area ranging from 80 to 100 g/m².

### EXAMPLES

Sheets of filter material according to the invention were prepared continuously. The characteristics of the internal centrifugation fiberizing process (using, as in EP 0 189 354, a tangential burner and a bottomless 400 mm diameter spinner dish with a basket) and of the filter media obtained are given in Table 1. Particularly mentioned in this Table 1 are:

the output, which is the mass of glass converted, in metric tons per day;

the pressure of the tangential burner, in mm of water column (denoted mmWC);

the fineness of the fibers, measured using the technique described in French patent application No. 02/06252; and

the weight per unit area of the filter medium.

The sheets of filter medium were then cut and converted into pocket filters. The properties of these pocket filters, all tested with an air velocity of 0.13 meters per second, are given in Table 2. Particularly mentioned in Table 2 are:

the initial opacimetric efficiency and the mean opacimetric efficiency, measured according to the EN 779 standard;

the initial spectral efficiency and the mean spectral efficiency measured according to the EN 779 standard;

the retention capacity and the class, both measured according to the EN 779 standard.

The properties of these filters were compared with those of similar filters having an equivalent weight per unit area, but prepared according to the Aerocor process.

Table 3 compares the efficiency of the two types of filter as regards retention capacity. It may be seen that, in each filter class (F5, F6, F7), the filters according to the invention have a higher retention capacity than the comparison Aerocor-type filter, despite equivalent weights per unit area.

An F8 filter class of 90-95% spectral efficiency was also obtained. This class has a weight per unit area of 80 g/m², a retention capacity of 55 g/m² and a mean spectral efficiency of 90%.

An F9 filter class could obviously also have been obtained with the process according to the invention.

In the case of internal centrifuging, the values were calculated with the following uncertainties:

for the weight per unit area: ±2% relative;

for the retention capacity: ±10% relative;

for the mean spectral efficiency: ±5% relative.

Despite these uncertainties, the benefit of the present invention over the Aerocor process of the prior art is obvious.

TABLE 1

| | Number of | | | | Weight per |
|---|---|---|---|---|---|
| | holes in the | | Pressure of | Fineness of | unit area of |
| Example | fiberizing | Characteristics of the | the loop | the fiber | the filter |
| No. | spinner dish | holes in the spinner dish | burner (mmWC) | (1/min) | medium (g/m²) |
| 1 | 4950 | 11 rows of holes with | 440 | 10 | 90 |
| | | diameters ranging from | | | |
| | | 0.6 to 0.5 mm | | | |
| 2 | 3150 | 7 rows of holes with | 440 | 4 | 80 |
| | | diameters ranging from | | | |
| | | 0.7 to 0.5 mm | | | |
| 3 | 9880 | 13 rows of holes with | 600 | 0.6 | 65 |
| | | diameters ranging from | | | |
| | | 0.7 to 0.5 mm | | | |

TABLE 2

| Example No. | | 1 | 2 | 3 |
|---|---|---|---|---|
| Initial pressure drop | Pa | 23 | 28 | 55 |
| Initial opacimetric efficiency | % | 27.50% | 35 | 64 |
| Initial spectral efficiency at 0.6 μm | % | 12% | 52 | 72 |
| Mean opacimetric efficiency | % | 71.4 | 73.5 | 85 |
| Mean spectral efficiency at 0.6 μm | % | 47.9 | 59.8 | 84.1 |
| Retention capacity | g/m² | 71 | 100 | 65 |
| Filter class | | F5 | F6 | F7 |

TABLE 3

| | Internal centrifuging | | | Aerocor | | |
|---|---|---|---|---|---|---|
| | Weight | | Mean | Weight | | Mean |
| | per unit | Retention | spectral | per unit | Retention | spectral |
| | area | capacity | efficiency | area | capacity | efficiency |
| Class | (g/m²) | (g/m²) | (%) | (g/m²) | (g/m²) | (%) |
| F5 | 90 | 71 | 47.9 | 90 | 50 | 50 |
| F6 | 80 | 100 | 59.8 | 78 | 38 | 61 |
| F7 | 65 | 65 | 84.1 | 65 | 33 | 86 |

1-24. (canceled)

25. A process for manufacturing a filter medium including a felt of mineral fibers bonded to a veil, the process comprising:
forming fibers by a device employing internal centrifuging, that includes a fiberizing spinner dish; then
spraying a precursor of a binder onto the fibers; then
collecting the fibers on a veil; and then
heat treating an assembly including the fibers and the veil with a controlled thickness to convert the binder precursor into a binder.
cm 26. The process as claimed in claim 25, wherein the veil is placed on a gas-permeable belt, the fibers being directed onto the veil by suction being applied through the veil and the belt.

27. The process as claimed in claim 25, wherein the fibers have a fineness index of at most 12 liters per minute.

28. The process as claimed in claim 27, wherein the fibers have a fineness index of at most 10 liters per minute.

29. The process as claimed in claim 25, wherein the fibers have a fineness index of at least 0.4 liters per minute.

30. The process as claimed in claim 25, wherein the spinner dish includes holes with a diameter ranging from 0.3 to 0.9 mm.

31. The process as claimed in claim 30, wherein the holes in the spinner dish have a diameter ranging from 0.4 to 0.8 mm.

32. The process as claimed in claim 25, wherein the device includes an internal burner.

33. The process as claimed in claim 25, wherein the device includes a tangential burner.

34. The process as claimed in claim 25, wherein the spinner dish is a bottomless spinner dish and is combined with a basket.

35. The process as claimed in claim 25, wherein the precursor of the binder is a phenolic or an acrylic or an epoxy.

36. The process as claimed in claim 25, wherein the controlled thickness ranges from 4 to 12 mm.

37. The process as claimed in claim 25, wherein a final filter medium generally comprises:
10 to 25% by weight of binder+oil+additive(s),
10 to 50% by weight of veil,
25 to 80% by weight of mineral material.

38. The process as claimed in claim 25, wherein the weight per unit area of the filter medium ranges from 30 to 110 g/m².

39. The process as claimed in claim 38, wherein the weight per unit area of the filter medium ranges from 50 to 90 g/m².

40. A filter medium manufactured by the process as claimed in claim 25.

41. A pocket filter having a mean spectral efficiency ranging from 80 to 90% and having a retention capacity, as measured according to the EN 779 standard, of at least 45 g/m², a filter medium of which has a weight per unit area ranging from 60 to 70 g/m².

42. The pocket filter as claimed in claim 41, wherein the retention capacity is at least 50 g/m².

43. The pocket filter as claimed in claim 42, wherein the retention capacity is at least 60 g/m².

44. A pocket filter having a mean spectral efficiency ranging from 60 to 80% and having a retention capacity, as measured according to the EN 779 standard, of at least 50 g/m², a filter medium of which has a weight per unit area ranging from 70 to 90 g/m².

45. The pocket filter as claimed in claim 44, wherein the retention capacity is at least 60 g/m².

46. The pocket filter as claimed in claim 45, wherein the retention capacity is at least 70 g/m².

47. A pocket filter having a mean spectral efficiency ranging from 40 to 60% and having a retention capacity, as measured according to the EN 779 standard, of at least 60 g/m², the filter medium of which has a weight per unit area ranging from 80 to 100 g/m².

48. The pocket filter as claimed in claim 47, wherein the retention capacity is at least 70 g/m².
